(19) United States
(12) Patent Application Publication
(10) Pub. No.: US 2009/0077537 A1
(43) Pub. Date: Mar. 19, 2009

(54) METHOD OF AUTOMATICALLY GENERATING TEST CASES TO TEST COMMAND LINE INTERFACES

(75) Inventors: Diane Gyesoon Chung, Poughkeepsie, NY (US); Mary Ellen Coleman, Pleasant Valley, NY (US); Sheau-ling Shih, Poughkeepsie, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/856,802

(22) Filed: Sep. 18, 2007

(51) Int. Cl. G06F 11/36; G06F 9/44

(52) U.S. Cl. 717/124

(57) ABSTRACT

A computer program product stored on machine readable media is provided and includes machine executable instructions for testing a command of a computer code, the instructions including instructions for: receiving input from a command description file and an options file; and assembling a plurality of modified commands for testing of the command as a script.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to testing of software implemented functions, and particularly to functions implemented at a command line interface.

2. Description of the Related Art

Many software programs make use of a command line interface. As is known in the art, the command line interface permits a user to input a command by simply typing in the command from a keyboard. Many commands make use of flags and other input parameters after the command for control of execution. However, when a developer is developing a new command, testing of the various flags and other input parameters may be laborious and time consuming.

More specifically, each option flag and parameter (and combinations of flags and parameters) associated with a given command must be tested. Currently, this testing is done manually by invoking the command on the command line. This approach limits each test case to a specific set of option flags and parameters. It is time-consuming, inflexible, and prone to error.

Personnel testing a command can reduce error in testing and speed up testing by coding the various option flags and parameters for a command into scripts. However, such techniques are also inflexible and time-consuming. For example, creating and managing these scripts, is time consuming. Further, if a command option, option value, or parameter value changes, the scripts must be updated accordingly.

What are needed are techniques for testing software commands implemented using a command line interface, where the testing provides for comprehensive and generally automated testing. What are needed are techniques such as those disclosed herein.

### SUMMARY OF THE INVENTION

The shortcomings of the prior art are overcome and additional advantages are provided through the provision of an embodiment of computer program product stored on machine readable media and including machine executable instructions for testing a command of a computer code, the product including instructions for: receiving input from a command description file and an options file; and assembling a plurality of modified commands for testing of the command as a script.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which provides for automated or nearly automated testing of commands during development thereof. More specifically, and as an example, we have achieved a solution which provides an embodiment of a computer program product stored on machine readable media and including machine executable instructions for testing a command of a computer code, is provided and includes instructions for: receiving input from a command description file including a command name and values for at least one of an option and a parameter associated with the command and an options file including an orthogonal array of information on viable combinations of options and parameters; and assembling a plurality of modified commands for testing of the command as a script.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates one example of a processing system for practice of the teachings herein; and

FIG. 2 illustrates one example of method for testing commands.

The detailed description explains the preferred embodiments of the invention, together with advantages and features, by way of example with reference to the drawings.

### DETAILED DESCRIPTION OF THE INVENTION

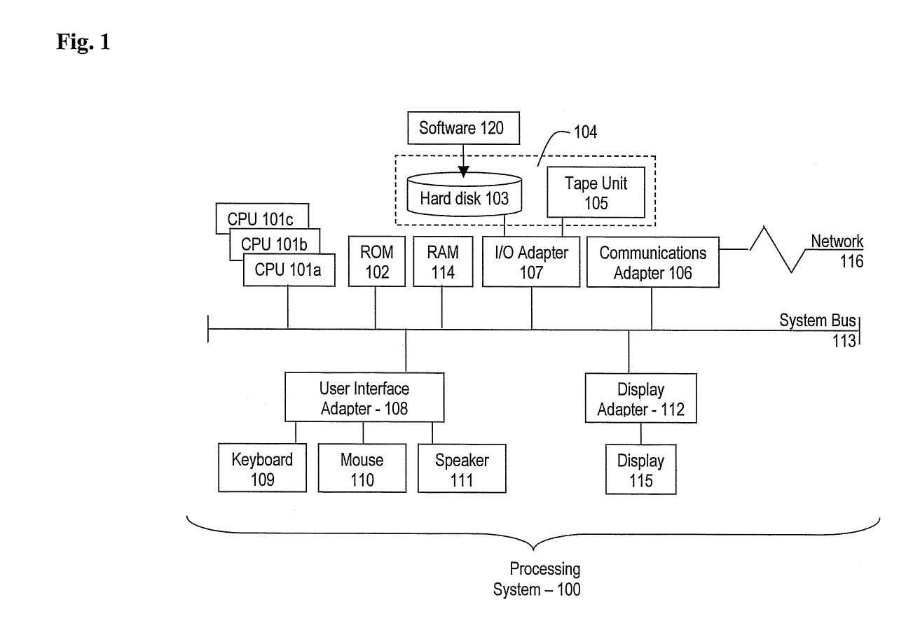

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing means in the form of processors 101, storage means including system memory 114 and mass storage 104, input means such as keyboard 109 and mouse 110, and output means including speaker 111 and display 115. In one embodiment, a portion of system memory 114 and mass storage 104 collectively store an operating system such as the AIX® operating system from IBM Corporation to coordinate the functions of the various components shown in FIG. 1.

It will be appreciated that the system 100 can be any suitable computer or computing platform, and may include a terminal, wireless device, information appliance, device, workstation, mini-computer, mainframe computer, personal digital assistant (PDA) or other computing device.

Examples of operating systems that may be supported by the system 100 include Windows 95, Windows 98, Windows NT 4.0, Windows XP, Windows 2000, Windows CE, Windows Vista, Macintosh, Java, LINUX, and UNIX, or any other suitable operating system. The system 100 also includes a network interface 116 for communicating over a network. The network can be a local-area network (LAN), a metro-area network (MAN), or wide-area network (WAN), such as the Internet or World Wide Web.

Users of the system 100 can connect to the network through any suitable network interface 116 connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

As disclosed herein, the system 100 includes machine readable instructions stored on machine readable media (for example, the hard disk 104) for capture and interactive display of information shown on the screen 115 of a user. As discussed herein, the instructions are referred to as “software” 120. The software 120 may be produced using software development tools as are known in the art. Also discussed herein, the software 120 may also referred to as a “command line testing tool” 120, an “a testing interface” 120 or by other similar terms. The software 120 may include various tools and features for providing user interaction capabilities as are known in the art.

In some embodiments, the software 120 is provided as an overlay to another program. For example, the software 120 may be provided as an “add-in” to an application (or operating system). Note that the term “add-in” generally refers to supplemental program code as is known in the art. In such embodiments, the software 120 may replace structures or objects of the application or operating system with which it cooperates.

The software 120 generally provides users with a capability to thoroughly and automatically test commands that issue from a command line. The commands may be native to (written to function within) computer application code programs (for example, C, C++, Perl, Java and others), other programs typically regarded as computing environments (UNIX, LINUX, DOS, and others) as well as other types of programs.

As a matter of convention herein, it is considered that the “software” 120 provides for testing of other “computer code.” It is recognized that computer code is commonly regarded as software, however, in the interest of avoiding confusion, use of the term “software” is generally limited to describing embodiments of computer implemented instructions and computer program products that provide for automated testing of at least one command of a computer code.

Also, as used herein, the term “automated” generally refers to a capability of the software 120 to perform testing with minimal, limited or no intervention or supervision by a user.

As some perspective on the software 120, consider the following. A command that is executed (i.e., “run”) from a command line interface often involves many option flags and parameters (referred to as “program control inputs”). The command output or execution may vary, depending upon the various combinations of options and parameters. In theory, all of the combinations of options and parameters must be tested to verify the correct output (or error message). In reality, only a subset of all possible combinations can be tested. With regard to the present invention, orthogonal arrays and other similar techniques can be used to create this subset of combinations of program control inputs.

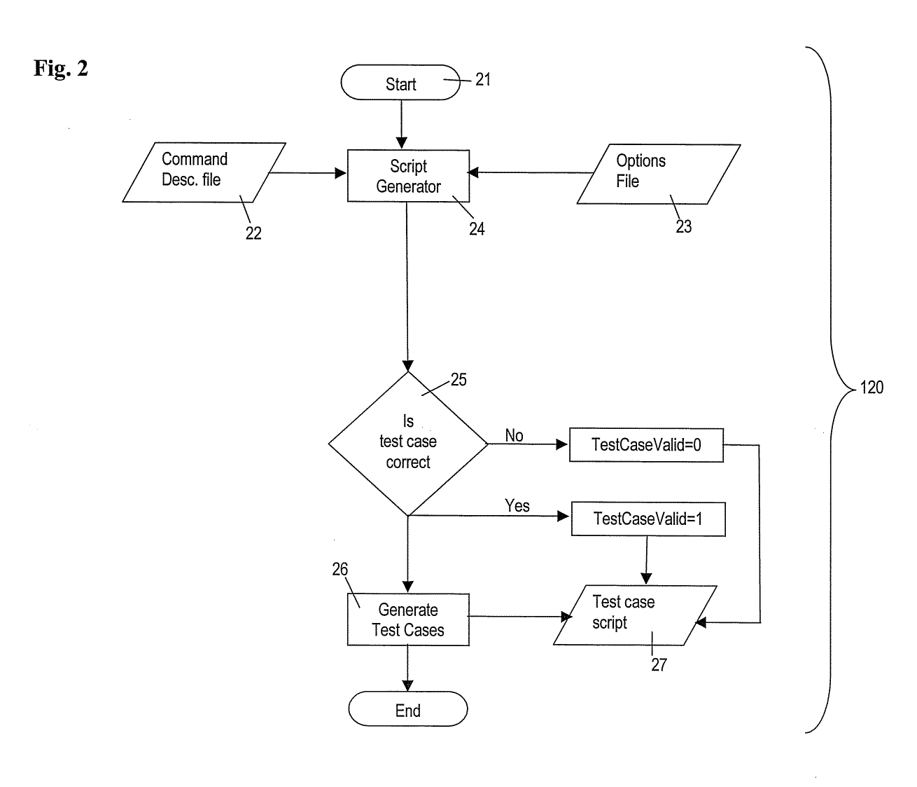

Referring now to FIG. 2, exemplary aspects of the software 120 (i.e., the testing tool 120) are shown. In FIG. 2, the aspects are shown as elements of a method for testing each command. Each of the elements includes machine readable instructions which may be stored on machine readable media for subsequent execution. Each of the elements may be stored separately, as one file, or by any other structure deemed appropriate by architects and developers of the software 120. Accordingly, the illustration of the various elements in FIG. 2 is merely illustrative and is not limiting of aspects of the invention.

The software 120 generally includes a script generator 24. The script generator 24 (named “genComm”, for example) receives input from two files (generally provided as text files). The first file (referred to as a “command description file” 22) includes information such as the command name and fixed values for the options and parameters. The second file (referred to as an “options file” 23) provides information on viable combinations of options and parameters. For example, the options file 23 may include information that the tester generated by using algorithms and tools that already exist. The options file 23 generally includes symbology such as binary values (for example, 0 omits an option or parameter from the command; 1 specifies the option or parameter). The tester adds the last column, indicating if the test case should return with or without error. This binary number provides automated test case verification.

When the software 120 is executed, the software 120 provides an output script that the tester can subsequently run to test the command. Generally, the script is provided in Perl.

As an example of the foregoing, consider Tables 1 and 2. First, an excerpt of the command description file 22 is provided as Table 1.

TABLE 1
Excerpt of Exemplary Command Description File

| mkcondition | | |
|---|---|---|
| r | IBM.Boson | 1 |
| e | OpState != 0 | 1 |
| E | OpState == 0 | 1 |
| d | Alert when the OpState of | 1 |
| | an IBM. Boson resource is | |
| | inactive | |
| D | Alert when the OpState of | 1 |
| | an IBM. Boson resource is | |
| | active | |
| m | p | 1 |
| n | c176n07, c176n11 | 1 |
| s | fvt1 | 1 |
| p | c176n11 | 1 |
| qnotoggle | quotoggle | 1 |
| S | w | 1 |
| condition | myCond | 1 |

In Table 1, the first line includes the name of the command. The following lines list the various options and parameters, along with test values, and whether the option or parameter is valid. An example of the options file 23 is provided as Table 2. In this example, the options file 23 includes an orthogonal array for testing the command.

TABLE 2
Excerpt of Exemplary Options File

| r | e | E | d | D | m | n | S | p | qnotoggle | S | T | V | name | valid |
|---|---|---|---|---|---|---|---|---|---|---|---|---|---|---|
| 1 | 1 | 0 | 1 | 0 | 0 | 0 | 0 | 1 | 1 | 0 | 1 | 0 | 1 | 1 |
| 1 | 1 | 1 | 0 | 1 | 0 | 0 | 0 | 1 | 1 | 1 | 0 | 0 | 1 | 1 |
| 1 | 1 | 1 | 0 | 1 | 0 | 0 | 1 | 0 | 1 | 1 | 1 | 1 | 1 | 1 |
| 1 | 0 | 1 | 0 | 0 | 0 | 0 | 1 | 1 | 1 | 0 | 0 | 1 | 1 | 0 |
| 1 | 1 | 0 | 0 | 0 | 0 | 0 | 0 | 1 | 1 | 0 | 0 | 1 | 1 | 1 |
| 1 | 1 | 0 | 0 | 0 | 0 | 0 | 0 | 0 | 1 | 1 | 1 | 1 | 1 | 1 |
| 1 | 1 | 0 | 0 | 0 | 0 | 0 | 1 | 1 | 1 | 1 | 1 | 1 | 1 | 1 |
| 1 | 1 | 1 | 1 | 1 | 0 | 0 | 1 | 0 | 1 | 0 | 0 | 0 | 0 | 0 |
| 1 | 1 | 0 | 0 | 0 | 0 | 0 | 0 | 1 | 1 | 1 | 0 | 0 | 1 | 1 |
| 1 | 1 | 1 | 1 | 0 | 0 | 0 | 0 | 1 | 1 | 1 | 1 | 0 | 1 | 1 |
| 1 | 1 | 0 | 0 | 1 | 1 | 1 | 0 | 0 | 1 | 0 | 0 | 0 | 1 | 1 |
| 1 | 1 | 1 | 0 | 0 | 1 | 1 | 1 | 0 | 1 | 0 | 1 | 0 | 1 | 1 |
| 0 | 1 | 1 | 1 | 1 | 1 | 1 | 1 | 0 | 1 | 1 | 1 | 1 | 1 | 0 |
| 1 | 1 | 1 | 1 | 1 | 1 | 0 | 0 | 0 | 1 | 0 | 0 | 0 | 1 | 1 |

In this example, the orthogonal array indicates whether a parameter is used or not. The last column indicates whether the combination of options is valid. Note that some options are mutually exclusive.

As an example, the tester would call the script generator 24 with a command line such as:

genComm mkcondition.txt oarray.txt

where the script generator 24 “genComm” builds a script, containing one complete command for each row of the orthogonal table. That is, the script generator 24 builds a plurality of modified commands for testing each command (i.e., the script generator 24 provides a plurality of appropriate program control inputs for modification of the command being tested). As an example of one modified command, the script generator 24 would provide the following:

system(“mkcondition -r IBM.Boson -e \“OpState !=0\” -p c176n11 -d \
“Alert when the OpState of an IBM.Boson resource is inactive\”
-T --qnotoggle myCond1”);

where Tables 1 and 2 are used as input files.

This command should complete without error because all required options and parameters are specified. The script generator 24 (named gencomm) stores the value that indicates this is a valid test case. When the script issues this command, it retrieves the return code from the system, and verifies it against the stored value. The tester can create additional test cases and scripts by simply changing the command description file 22, the options file 23 or both.

The script generator 24 provides advantages over the prior art as it uses input files that allow it to be “smarter” about which permutations to include and exclude. The tester has total control over which permutations to test because the input files have a simple structure and can be created easily and quickly.

Accordingly, the script generator 24 provides for generating scripts for testing syntax variations in a command. The script generator 24 is not specific to any particular hardware or software configuration. In general, a user need only to provide a configuration file. The script generator 24 produces output that results in uniform test case scripts that run without error. Advantageously, the script generator 24 can be adapted to other command line interface (CLI) functions.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately. Additionally, at least one program storage device readable by a machine, tangibly embodying at least one program of instructions executable by the machine to perform the capabilities of the present invention, can be provided.

The flow diagram depicted herein is just one example. There may be many variations to this diagram or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may male various improvements and enhancements which fall within the scope of the claims which follow. These claims should be construed to maintain the proper protection for the invention first described.

What is claimed is:

1. A computer program product stored on machine readable media and comprising machine executable instructions for testing a command of a computer code, the product comprising instructions for:
receiving input from a command description file and an options file; and
assembling a plurality of modified commands for testing of the command as a script.

2. The computer program product of claim 1, wherein the command description file comprises a command name and values for at least one of an option and a parameter associated with the command.

3. The computer program product of claim 1, wherein the options file comprises information on viable combinations of options and parameters

4. The computer program product of claim 3, wherein the options file comprises an orthogonal array of options and parameters.

5. The computer program code of claim 4, wherein the orthogonal array comprises binary values.

6. The computer program product of claim 1, wherein the product is provided as supplemental program code.

7. A computer program product stored on machine readable media and comprising machine executable instructions for testing a command of a computer code, the product comprising instructions for:
receiving input from a command description file comprising a command name and values for at least one of an option and a parameter associated with the command and an options file comprising an orthogonal array of information on viable combinations of options and parameters; and
assembling a plurality of modified commands for testing of the command as a script.
